(19) United States
(12) Patent Application Publication
(10) Pub. No.: US 2006/0286419 A1
(43) Pub. Date: Dec. 21, 2006

(54) Fuel cell system with consumption-optimizing unit

(76) Inventors: Juergen Binder, Filderstadt-Plattenhardt (DE); Ulrich Gottwick, Stuttgart (DE); Arthur Schaefert, Buehlertal (DE)

Correspondence Address: STRIKER, STRIKER & STENBY, 103 EAST NECK ROAD, HUNTINGTON, NY, 11743, US

(21) Appl. No.: 11/451,019

(22) Filed: Jun. 12, 2006

(30) Foreign Application Priority Data
Jun. 15, 2005 (DE) 10 2005 027 651.2

(51) Int. Cl. H01M 8/04

(52) U.S. Cl. 429/22; 429/34

(57) ABSTRACT

A fuel cell system which including a fuel cell, a fuel tank and a consumer unit, to improve the operation of a fuel cell, is equipped with a consumption-optimizing unit that limits or interrupts the energy supply to one or more consumers of the consumer unit depending on the fill level of the fuel tank in order to ensure at least the basic function of the fuel cell system for as long as possible.

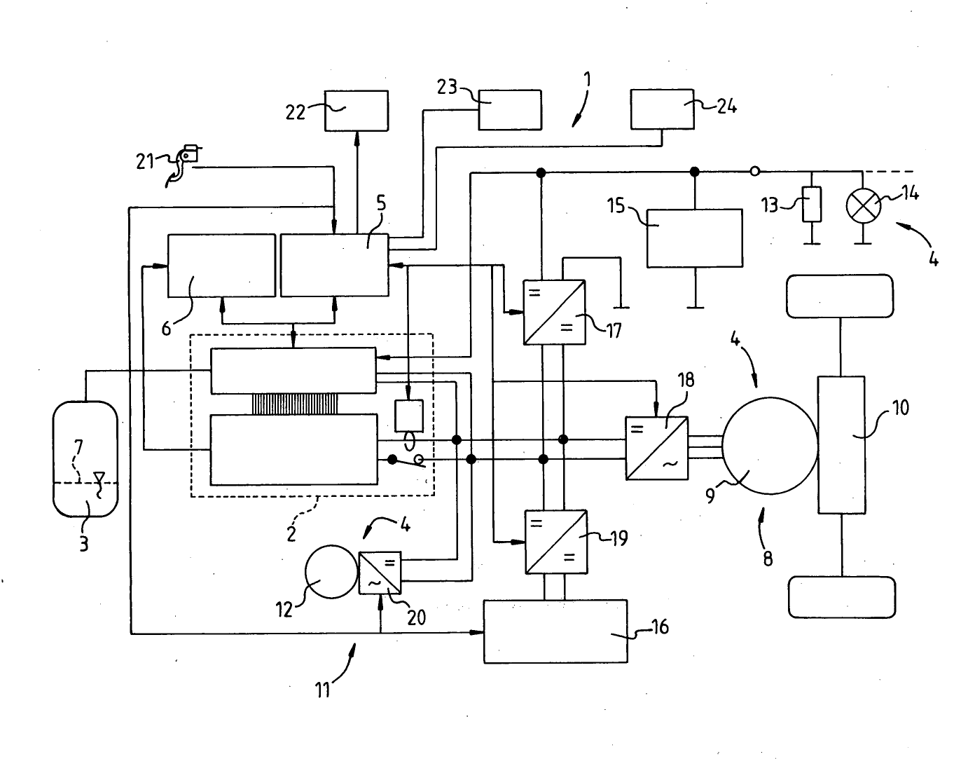

### CROSS-REFERENCE TO A RELATED APPLIACTION

The invention described and claimed hereinbelow is also described in German Patent Application DE 102005027651.2 filed on Jun. 15, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a fuel cell system with consumption-optimizing unit.

Fuel cell systems for stationary and mobile use are becoming increasingly important. In terms of utilizing the consumers operated by the fuel cell systems, a decisive factor is the presence of a sufficient quantity of fuel, which is preferably stored in a fuel tank assigned to the fuel cell system.

The fill level of a gas tank filled under high pressure, as is the case, e.g., with a fuel tank for storing fuel for a fuel cell system, can be determined very exactly and displayed by using Van der Waals equation and with consideration for the pressure and temperature in the tank. During operation of a fuel cell system it cannot be ruled out, however, that the quantity of fuel stored in the fuel tank will fall below a minimum quantity required to operate the consumer supplied with energy by the fuel cell.

### SUMMARY OF THE INVENTION

Accordingly, it is an object of the present invention is to improve a fuel cell system of this type.

In keeping with these objects and with others which will become apparent hereinafter, one feature of the present invention resides, briefly stated, in a fuel cell system, comprising a fuel cell; a fuel tank; a consumer unit; and a consumption-optimizing unit.

The fuel cell system according to the present invention is therefore characterized by the fact that it is equipped with a consumption-optimizing unit. It is provided, in particular, that the consumption-optimizing unit monitors the fill level of the fuel tank assigned to the fuel cell system and, depending on the result, initiates measures to optimize consumption, if necessary.

It is also advantageous for the consumption-optimizing unit to also monitor the energy demand and/or energy supply to a consumer unit.

This procedure is based on the finding that the consumer unit supplied with energy from the fuel cell does not necessarily have to be supplied with 100% of the energy it requires to adequately fulfill the main task of the consumer unit.

It is advantageous, in particular, when the consumer unit can be operated in different operating modes to fulfill its primary task.

With mobile fuel cell systems, e.g., in a vehicle, it is of primary importance for this fuel cell system to remain in motion. With stationary fuel cell systems, e.g., in a heating system, it can be of primary importance, e.g., to ensure that appropriate heating energy is supplied to heat rooms or, if necessary, to heat only certain rooms, in order to ensure that the desired temperature is maintained in these rooms.

To this end it is particularly advantageous when the consumption-optimization unit can limit the energy supply to one or more consumers of the consumption unit depending on the fill level of the fuel tank. With a mobile fuel cell system it would be possible, e.g., to first limit the energy supply or disconnect it entirely, if necessary, from consumers that perform secondary functions, e.g., the air conditioning system, windshield heating system, and the like. The limiting or interruption of the energy supply to one or more consumers can therefore take place as a function of a priority value of the particular consumer.

The same applies for stationary fuel cell systems, with which the energy supply from the fuel cell to consumers that perform secondary functions within the entire consumer unit can also be limited or interrupted entirely by measures carried out by the consumption-optimizing unit. The secondary functions can be, e.g., heating the water, secondary heating circuits, any user-friendly options provided that may be provided with the stationary fuel cell system, supplying energy to various ancillary power circuits and the like.

It is also advantageous when the consumption-optimizing unit signals that it is limiting or interrupting the energy supply to one or more consumers. It is advantageous in particular for a signaling of this type to take place in advance, before the intervention is carried out. With a mobile fuel cell system, the signaling can be, e.g., a message transmitted to the driver of a motor vehicle propelled by the mobile fuel cell system, e.g., in the form of an optical or acoustic warning. A warning of this type can also be transmitted in stages, for example, so that, if the fuel level in the accumulator or tank continues to fall below a certain level, an increased signaling frequency and/or an additional alarm display is activated. This procedure is also suitable for use, in general, with stationary fuel cell systems.

To reduce the amount of energy consumed by the consumption unit, it is possible for the consumption-optimizing unit, in a further step, to switch to a different operating mode, and if necessary, to change the availability of the vehicle propulsion to limited or even minimum functionality, in order to increase the fuel efficiency of the motor vehicle that can be obtained from the remaining quantity of fuel.

A further possibility would be to integrate available intermediate energy accumulators in the drive of the consumers, so that a portion of the operation of the fuel cell can be temporarily reduced or even interrupted entirely, in order to save more fuel. Another possibility, therefore, is to forfeit a portion of the dynamics of vehicular operation as a secondary property of the drive system instead of increasing fuel efficiency, in order to reach a refueling station.

To support the primary requirement on the fuel cell system, i.e., to increase the distance to empty of the motor vehicle, it is also considered advantageous for the consumption-optimizing unit to interact with a navigation system. This makes it possible to display the location of refueling stations to the operator, so he can drive to a refueling station, fill the tank, and avoid having the motor vehicle come to a standstill. Other types of optimizations based on the driving route, distance and traffic conditions are possible, of course.

It is also considered advantageous when the consumption-optimization unit interacts with a tank management device. In this case it is possible, e.g., for this tank management device to transmit tank-specific information to the refueling station. This information can be, e.g., the quantity required to fill the fuel accumulator or tank, its temperature, internal pressure or the like.

It is also considered advantageous when the consumption-optimization unit and/or the tank management device enables communication with the refueling station or a service station, in order to notify the station that the output of the fuel cell system has been reduced, and to request assistance, if necessary.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single figure of the drawings is a view showing a fuel cell system with a consumption-optimizing unit in accordance with the present invention.

### DESCRIPTION OF THE PREFERRED EMBODIMENTS

The fuel cell system is a consumption-optimizing unit in accordance with the present invention is shown in the drawings.

The fuel cell system is identified with reference numeral 1. The fuel cell system includes a fuel cell 2, a fuel cell tank 3, and a consumer unit 4.

According to the present invention, this fuel cell system 1 is equipped with a consumption-optimizing unit 5 that monitors fill level 7 of fuel tank 3 in order to monitor the energy demand and/or energy supply to consumer unit 4, which can be operated in different operating modes. In one or more of these operating modes, consumption-optimizing unit 5 is capable of limiting and even interrupting, if necessary, the energy supply to one or more consumers 8, 11, 13, 14 of consumer unit 4 as a function of fill level 7 of fuel tank 3.

With mobile fuel cell system 1 shown here as an example, the consumers (Vx)—which are also presented as examples—are consumer 8, which is the drive of the motor vehicle, which is composed of electric motor 9 and transmission 10 coupled therewith, consumer 11 is an electric motor 12 shown as an example to drive an air conditioning system, consumer 13 is an electrical resistor, e.g., in the form of a windshield heater, consumer 14 is a lamp, e.g., in the form of a headlight. Additional consumers for all possible functions of a motor vehicle can also be present, e.g., windshield wipers, power sunroof drive units, audio systems and the like.

The limiting or interruption of the energy supply to one or more consumers by consumption-optimizing unit 5 can take place, in particular, as a function of a priority value of the particular consumer. The lower the priority is of the consumer, the more quickly it will be shut off upon detection that the fill level has fallen below a certain level, the consumers being, in this case, e.g., the air conditioning system, the windshield heating system and the like.

An intervention of this type into the energy supply can be signaled by consumption-optimizing unit 5 using a signaling device 22 attached thereto, this signaling preferably taking place clearly before the intervention is carried out, so the driver can become accommodated to a different operating behavior of this mobile fuel cell system or even take countermeasures.

Consumption-optimizing unit 5 can provide various operating modes for the intervention into the energy supply. It is capable of successively limiting or even interrupting the energy supply to the various consumers in accordance with their priorities, and an operating mode can be provided that acts on the drive train of the motor vehicle such that it is driven in an economy mode in order to use as little energy as possible, so that the range of the motor vehicle can be maximized with the quantities of fuel that remain.

To this end, e.g., the speed of the motor vehicle can be limited, while energy is simultaneously utilized in an optimum manner within the range of the best efficiency of the energy and power train. In this context, it is also feasible for consumption-optimization unit 5 to intervene in the shifting behavior of the transmission, in particular in harmony with the engine speed and the load being placed on it due to the inclination of the road.

Advantageously, consumption-optimization unit 5 can interact with a navigation system 23, so that the location of refueling stations that can be reached with the quantity of fuel remaining in the motor vehicle can be displayed to the driver.

A tank-management device 24 supplements this mobile fuel cell system such that—possibly in interaction with consumption-optimizing unit 5—contact can be established with a refueling station in order to notify it that a motor vehicle is approaching it that might have problems with the fuel supply, or to notify it of the quantity of fuel required to fill the fuel tank of the motor vehicle. In addition, the data pertaining to the filling pressure, the temperature of fuel tank 3 and the like can be transmitted.

Energy converters 17-20 and a connection 21 for an external energy supply supplement the most important components of this fuel cell system.

It will be understood that each of the elements described above, or two or more together, may also find a useful application in other types of constructions differing from the types described above.

While the invention has been illustrated and described as embodied in a fuel cell system with consumption-optimizing unit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A fuel cell system, comprising
a fuel cell;
a fuel tank; a consumer unit; and
a consumption-optimizing unit.

2. A fuel cell system as defined in claim 1, wherein said consumption-optimizing unit is configured so that it monitors a fill level of said fuel tank.

3. A fuel cell system as defined in claim 1, wherein said consumption-optimizing unit is configured so that it monitors a parameter selected from the group consisting of an energy demand, an energy supply, and both to said consumer unit.

4. A fuel cell system as defined in claim 1, wherein said consumption-optimizing and said consumer unit are configured so that different operating modes are provided for said consumption-optimizing unit and said consumer unit to fulfill a primary task of said consumer unit.

5. A fuel cell system as defined in claim 1, wherein said consumption-optimizing unit is configured so that it limits an energy supply to one or more consumers of said consumer unit depending on a fill level of said fuel tank.

6. A fuel cell system as defined in claim 1, wherein said consumption-optimizing unit is configured so that it interrupts an energy supply to one or more consumers depending on a fill level of said fuel tank.

7. A fuel cell system as defined in claim 1, wherein said consumption-optimizing unit is configured so that it limits or interrupts an energy supply to one or more consumers as a function of a priority value of a particular consumer.

8. A fuel cell system as defined in claim 1, wherein said consumption-optimizing unit is configured so that it signals that it is limiting or interrupting an energy supply to one or more consumers.

9. A fuel cell system as defined in claim 1, wherein said consumption-optimizing unit is configured so that it interacts with a navigation system.

10. A fuel cell system as defined in claim 1, wherein said consumption-optimization unit is configured so that it interacts with a tank management device.
